(19) United States
(12) Patent Application Publication
(10) Pub. No.: US 2023/0272998 A1
(43) Pub. Date: Aug. 31, 2023

(54) METHODS AND SYSTEMS FOR DIGITAL IMAGE-REFERENCED INDIRECT TARGET AIMING

(71) Applicant: Kwesst Inc., Ottawa (CA)

(72) Inventor: Jose Hyunju Lee, Ottawa (CA)

(21) Appl. No.: 18/006,055

(22) PCT Filed: Jul. 19, 2021
(86) PCT No.: PCT/CA2021/050993

§ 371 Date: Jan. 19, 2023

Related U.S. Application Data
(60) Provisional application No. 63/054,435, filed on Jul. 21, 2020.

(51) Int. Cl. F41G 3/14; G06T 7/33

(52) U.S. Cl. CPC F41G 3/14; G06T 7/337

(57) ABSTRACT

There is provided methods and systems for digital image-referenced indirect target aiming. The systems and methods of the invention measures angle of rotation of subsequent stable images from an initial Reference Image and provide an aiming that is colinear to the target's absolute azimuth.

### FIELD OF THE INVENTION

This invention pertains generally to target aiming and, more particularly to methods and systems for digital image-referenced indirect target aiming.

### BACKGROUND OF THE INVENTION

Indirect fire is aiming and firing a projectile without relying on a direct line of sight between the weapon and its target, as in the case of direct fire. Indirect fire provides the capability to fire to an enemy without being under direct fire from them.

The achievement of a successful indirect fire is more difficult than direct fire, as users have to rely on certain instruments or sensors to aim at a target that is not in sight. There are two key variables in aiming a weapon—the angle in the horizontal plane—henceforth called azimuth, and the angle of the vertical plane—henceforth called elevation. Precise elevation is relatively easy to obtain, as digital accelerometers can provide precise, repeatable, and consistent values if the weapon is stationary for aiming.

Aiming weapons using digital magnetic compass for azimuth is not precise if the compass is under influence of magnetic field introduced by tools, ground/floor/wall/support structure content of magnetic materials, munitions including ammunition and weapons, batteries, or magnetic metals carried by a user. To use a magnetic compass successfully, aiming needs to have a strict control of the magnetic environment, which is impractical for military operations at the soldier level.

Aiming using MEMS (Micro-Electro-Mechanical Systems) gyroscopes for azimuth are also not precise as most of them provide incorrect values due to gyroscopic drift and cannot provide precise angular speed measurements when a weapon is fired due to the shock saturating gyroscope's angular measurement limits.

Although Ring Laser Gyroscopes (RLG) and Fiber Option Gyroscopes (FOG) in general provide better performance than the MEMS gyroscopes (usually one order of magnitude for Bias Stability), it was not appropriate for application at the soldier level, for its cost (more expensive than MEMS gyroscopes), size (larger gyroscopes provide more precision), increased electrical power requirements, and to the fact that even RLG's and FOG's are not immune to shocks as encountered during a projectile fire.

Despite advancements on miniaturization of magnetic compass and gyroscopes, their applicability for projectile aiming at the soldier level is limited due to the reasons explained previously.

Fusion of plurality of sensors can also be used for aiming applications, but because individual sensors listed above are not precise, the fusion method that relies on either the sum or the best of sensors cannot guarantee a precise aiming either.

Umakhanov et al., (U.S. Pat. No. 9,595,109) uses a specific marker object or electronic marker for optical tracking with inertial sensors but placing or identifying objects may not be practical for field applications. Hartman et al., (U.S. Pat. No. 10,605,567) uses mechanical assemblies to sight a target and but requires the target to be in sight. Houde-Walter, et al. (U.S. Pat. No. 10,495,413) requires the target to be illuminated with a beam of thermal radiation.

Therefore, there remains a need to have a practical yet precise system for Indirect Fire aiming artillery weapons at the soldier level that is not affected by magnetic field distortions, or by angular errors caused by gyroscopic drifts. The present invention addresses those issues by using digital images of the area taken from a mount on the weapon. The digital images thus taken, are not affected by any magnetic distortions, and images taken before and after the projectile fire will be consistent, repeatable and reliable provided that camera is not damaged during the shock. Miniature/small solid-state digital cameras without moving parts survive high shocks as encountered during a projectile fire, without any damage.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide methods and systems for digital image-referenced indirect target aiming. In accordance with an aspect of the present invention, there is provided a computer implemented method of displaying absolute azimuth of an image, the method comprising receiving a reference digital image and a subsequent digital image, wherein the reference digital image and the subsequent digital image are captured from a known fixed point and wherein the reference digital image's absolute azimuth is known, and wherein the reference digital image and the subsequent digital image overlap; determining net rotation between the reference digital image and the subsequent digital image provides the absolute azimuth of the subsequent image. A successful target aiming will occur when the subsequent image's azimuth is the same as the target azimuth.

In accordance with another aspect of the invention, there is provided a computer implemented method of aiming at a target with a known target azimuth comprising capturing a reference digital image with a weapon mounted digital camera or digital video recorder; the reference digital image must have a known absolute azimuth; calculating the difference between the known absolute azimuth and the subsequent azimuth from camera images; rotating the weapon mounted digital camera until the weapon's azimuth matches with the target azimuth thereby providing colinear targeting to the target.

In accordance with another aspect of the invention, there is provided a system comprising a source of digital images such as a plurality of digital cameras or digital video recorders; one or more processors; and memory storing one or more programs to be executed by the one or more processors, the one or more programs comprising instructions for the any methods of the invention to improve the performance of the invention.

### BRIEF DESCRIPTION OF THE DRAWINGS

These and other features of the invention will become more apparent in the following detailed description in which reference is made to the appended drawings.

FIG. 1 illustrates a simplified point by point comparison of overlapping digital images taken from a fixed viewpoint. In the illustrated embodiment, a digital camera takes two pictures of a scene with a couple of trees and mountains in the background by pivoting from a single rotating viewpoint. The rotation of the camera (100) is in substantially the horizontal plane. The first image henceforth called the Reference Image (200), an image where the azimuth of the center of the image is known, and the second one called subsequent image (300). The images are shown on the scenery with an overlapping sub-image.

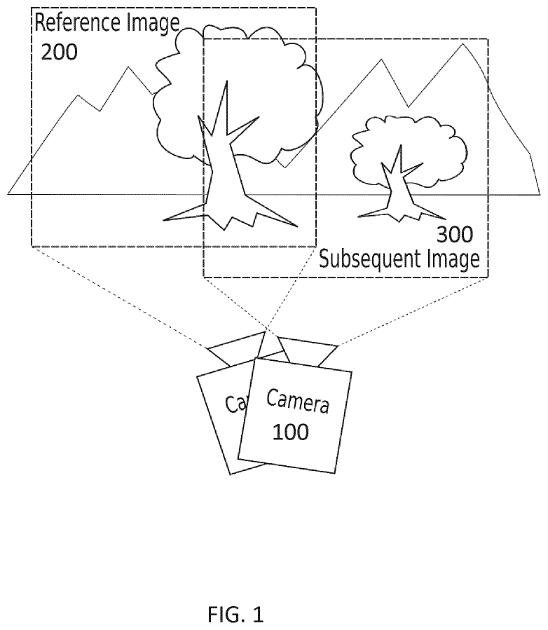

FIG. 2 illustrates a simplified determination of angle using a point-by-point comparison of overlapping images. For illustration only, the figure illustrates the usage of a single point. In the invention a plurality of points and accuracy rating filters are used to improve precision, reliability, repeatability, and confidence level. The angle formed by the point, Initial Angle (150), at the root of the tree with the left edge of the Reference Image (200) is measured. If the same point is identified on the subsequent image (300) (bottom, left corner of Common Sub-image (275), the invention measures the angle, Subsequent Angle (350), to the edge again. The invention then produces the difference of the angle as the calculated rotation of the camera. In FIG. 2, the angle of rotation of the camera (100) is the Subsequent Angle minus Initial Angle. The absolute azimuth of the center of the Subsequent image can be calculated then by adding the difference to the azimuth of the center of the Reference Image (200). Elevation angles can also be found using the same method. The rotation angle is easily calculated from the pixel location of the point using basic trigonometric functions with FOV (Field of View of the camera) and image pixel dimensions as given fixed values. For illustration, if a point in the center of the Reference Image moved horizontally x pixels, then its rotation angle can be determined by arc tangent of x divided by h. Where h is the distance in pixels from the image to the camera lens that can be calculated as image pixel width divided by 2 divided by tangent (FOV/2).

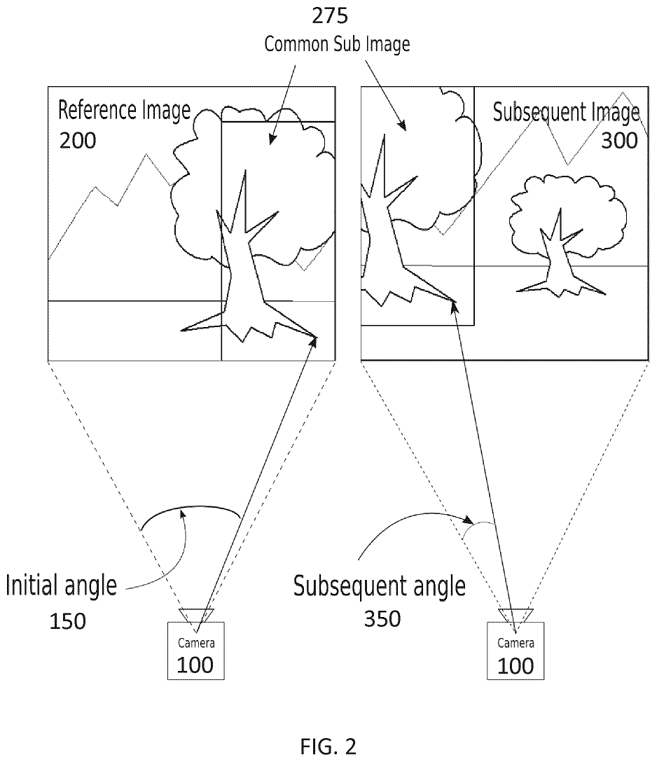

$$Rotation Angle = arctan ( \frac{x}{h} ) \\ Where h = arctan ( \frac{ImageWidth}{2 tan ( \frac{FOV}{2} )} )$$

FIG. 3 illustrates colinear targeting. The user has line of sight to a marker (400) (any object or geographical feature) with known absolute azimuth. The user however does not have line of sight to the target due to the obstacle (500) but is given the target azimuth (650). To aim at the target (600 that is not visible, the user of the system would aim the camera at the marker (400) to obtain the Reference Image (200) first thus establishing the Reference Azimuth (450), then rotate until the invention displays an azimuth that is colinear to the target azimuth (650), i.e., rotate the equivalent of the azimuth difference. The system calculates the camera's azimuth by first calculating the rotation angle and adding the Reference Azimuth (450). Direction of True North (800) is shown.

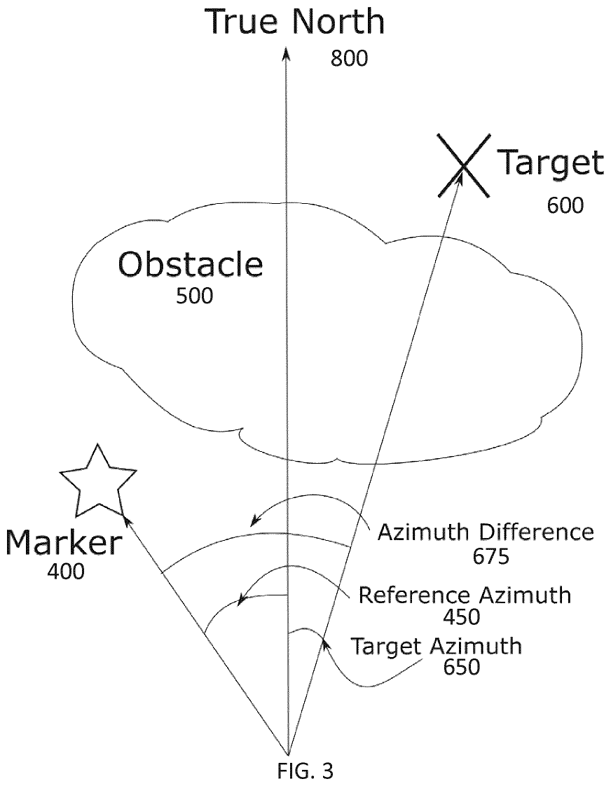

### DETAILED DESCRIPTION OF THE INVENTION

This invention provides methods and systems for digital image-referenced indirect target aiming. The invention also provides an indirect target aiming that is not affected by magnetic disturbance or shock of the projectile fire, as the digital images are not affected by magnetic disturbance and images after shot allow precise angle measurements.

In particular, the methods and systems identify an aiming that is colinear to the target's absolute azimuth from a Reference Image with an absolute azimuth. The methods and systems use measurements of angle of rotation of a camera determined by comparing at least one subsequent image to the initial Reference Image. Using the determined angle of rotation and the known absolute azimuth of the Reference Image, the azimuth of a subsequent overlapping image can be calculated.

In some embodiments, the system and method are configured to calculate horizontal or vertical angular difference of a subsequent image that has overlapping sub-image with common reference points, source camera's field of view and digital image size.

The initial Reference Image and the subsequent image(s) are obtained by capturing digital images from different view directions at a fixed viewpoint. Overlap between the initial Reference Image and the subsequence image(s) are assessed and the angle of rotation and optionally translation and tilt of the camera are determined. In some embodiments, a series of overlapping images are used. Methods of assessing image overlap are known in the art and include pixel by pixel comparison of overlapping images, feature detection and feature matching.

Generally, the images used by the methods of the invention are clear, in focus images without lens distortion, blurring, scene motion, and exposure differences. In some embodiments, the method and system are configured to reject a series of images or one or more images in a series not meeting a minimum set of azimuth precision standards. In some embodiments where a series of images has been taken the methods and systems of the invention are configured to select the optimal image or images.

Optionally, the methods and systems alert the user of poor image quality and request additional images be captured.

In some embodiments, a record of image or images used in the method or system for targeting is maintained.

In some embodiments, pixel-to-pixel mapping relation between the images is calculated.

In some embodiments, the invention filters out inconsistent pixel measurements such as those due to the presence of parallax, or those caused by wind and water.

In some embodiments, the method and system provide for pre-processing including re-orienting images to increase the probability of finding and associating those points and/or other transformation to correct for deviation from the horizontal plane. Accordingly, in some embodiments, the camera or video recorder used in the method or as part of the system includes one or more sensors to determine camera's orientation in space.

In some embodiments, pre-processing steps include image rectification for deformed images cause by lens distortion.

Digital images include photographs or video images. Accordingly, the system may include a database of images, a digital camera, and/or a digital video recorder. Optionally, cameras with sensitivity to different light spectrum frequencies such as thermal, infrared or ultraviolet cameras can be used to aim at night or fog conditions.

In some embodiments, two or more digital cameras or video recorders are provided, preferably the digital cameras or video recorders are identical. Optionally, the system and method can be configured to capture images from those cameras. When multiple cameras or video recorders are present, the system is configured to ensure that digital cameras or video recorders are fixed so they always rotate together. In such embodiments, the method and system may be configured such that the images from those cameras are taken as multiple Reference Images to increase the effective horizontal/vertical coverage arc of the invention.

The system and method are optionally configured to allow a user to identify the initial Reference Image with an absolute azimuth. Optionally, a plurality of images with known absolute azimuth and/or elevation angles can be set as References Images. In such embodiments, a calculated azimuth is optionally confirmed and may be provided with a confidence or accuracy rating. Optionally, if confidence or accuracy rating is below a pre-determined set point, the targeting system or associated ballistic application advises against firing weapon.

Accordingly, in some embodiments the system provides a user interface that allows a user to select the initial Reference Image and optionally one or more other Reference Images with their GPS location, azimuth, elevation and roll angle.

In some embodiments, the subsequent image can be compared to a database containing a plurality of Reference Images, wherein the database includes GPS coordinates, azimuth, elevation and roll for the images. Optionally, each Reference Image in the database is time and date stamped and may further include an indication of likelihood of whether there have been significant changes in the environment at the location (e.g., resulting from bombing, natural disaster and/or construction) of the Reference Image that would impact overlap with current images. Out-of-date Reference Images are optionally purged from the database and/or replaced with updated Reference Images. If sufficient common points are identified from a database image, the image is automatically selected by the system as the Reference Image.

In such embodiments, the database may be automatically searched for appropriate Reference Images by GPS coordinates and/or by a digital image search. In embodiments where the database is searched using a digital image, a digital image is captured by the user of the method or system. The method or system compare, using computer programs known in the art, the captured image with the database images, optionally pre-selected based on GPS coordinates and/or geographical location and select one or more Reference Images with sufficient common points. In some embodiments, the method and system are configured to compare fixed features in the digital image, for example, an algorithm may be used to identify cars or other non-fixed objects in digital image and disregard the corresponding pixels in the comparison. Algorithms for identifying and/or classifying objects in a digital image are known in the art. In some embodiments, the method and system may further use algorithms to identify seasonally changeable elements (e.g., snow coverage, foliage etc.) in Reference Image and disregard the corresponding pixels

The method and system may be configured to allow a user to set an overlap threshold.

Optionally, the system is configured to display an image overlap of the captured image and the selected one or more Reference Images.

In some embodiments, the system creates new Reference Images automatically if it detects that the number of reference points are decreasing but it still has a reliable azimuth and there is no other better Reference Image for the azimuth the system is aiming at. The newly created Reference Image would contain much more reference points that would further increase the coverage arc of the system.

Optionally, the methods and systems may be configured to use one or more digital maps to obtain Reference Azimuths based on a map feature and location of the source of the camera. In some embodiments, the Reference Azimuth is obtained by using a recognizable geographical point on a digital map and the locating the source camera using either map features or GPS.

In some embodiments, the system and method are configured to obtain a Reference Azimuth from the user when the user points the weapon to a marker with known azimuth thus establishing a Reference Image.

In some embodiments where the camera is directly mounted to the weapon or where the camera is a component of the weapon sight, azimuths are calculated in real time with the capture of images as the weapon is rotated and optionally an alert is provided when a pre-set or pre-determined azimuths is reached, wherein the pre-set or pre-determined azimuth is colinear with the target.

Optionally, the methods and systems are configured such that the center of a digital image corresponds to certain angular offset from the center of the weapon's sight and wherein the calculated azimuth with the offset is the azimuth colinear with the center of the weapon's sight.

In some embodiments, the camera is mounted parallel to the barrel of the weapon such that the image of the barrel is minimized in the digital image.

In some embodiments, the weapon with camera is mounted and rotation of the weapon to the pre-determined azimuth and elevation is controlled by methods and systems of the inventions.

The system is typically in the form of a computer system, computer component, or computer network operating software or in the form of a “hard-coded” instruction set and includes or is operatively associated with a weapon mounted digital camera or digital video recorder. In some embodiments, the weapon mounted digital camera or digital video recorder is a component of the sight of the weapon. This system may take a variety of forms with a variety of hardware devices and may include computer networks, handheld computing devices, personal computers, smart phones, microprocessors, cellular networks, satellite networks, and other communication devices. In some embodiments, the system and method include a handheld computing device application that is configured to receive digital images or videos from the weapon mounted digital camera or digital video recorder. As can be appreciated by one skilled in the art, this system may be incorporated into a wide variety of devices that provide different functionalities.

Accordingly, in one embodiment of the invention, the system includes a digital camera operatively connected to a processing device such as smart phone, personal computer or microprocessor for digital communication. The connection between the camera and the processing device may be wired or wireless.

The processing device includes a user interface that allows for the input of either a Reference Azimuth value for a given digital image or sufficient information that would allow the Reference Azimuth value. The processing unit processes subsequent digital images from the camera, determines the angle offset from the Reference Image and outputs its computed absolute azimuth. In some embodiments, if the camera deviates outside the field of view (FOV) of the Reference Image(s) or does not find enough common points, the system will output a message indicating that angle measurement is not possible.

In some embodiments, the system includes a digital camera, and an orientation sensor containing accelerometer sensor, connected to a processing device. In this embodiment, the system is able to produce azimuth from a Reference Image(s) and obtain elevation angle and roll angle from the accelerometer providing the 3 orthogonal angles needed for aiming a projectile.

In some embodiments, the system includes a digital camera, and an orientation sensor containing accelerometer sensor, and gyroscope, connected to a processing device. In this embodiment, the system can produce azimuth, elevation and roll angle for aiming. The methods and systems of the invention provide a means for synchronizing the gyroscope as well. In this embodiment, if the user aims at an area not covered by Reference Image, or insufficient common points are found, the system can still produce an azimuth using the gyroscope.

In some embodiments, the system has a plurality of cameras each pointing to a different azimuth, and an orientation sensor containing accelerometer. In this embodiment, each camera can have its own Reference Image and azimuth/elevation, therefore expanding horizontal and vertical arc coverage of the system.

In some embodiments, the system has a digital camera, and an orientation sensor containing accelerometer sensor and gyroscope, connected to a processing device and is configured to process multiple Reference Images taken by the camera at different orientations. The system then uses these Reference Images to provide the best azimuth/elevation/roll angles for subsequent images by selecting the best match Reference Image thus expanding the angle coverage of the system. To further optimize the system, the multiple Reference Images can be stitched together providing a single wide Reference Image that can be used by subsequent images to calculate the azimuth of the system.

Optionally, in some embodiments, the system is configured to capture multiple images when the system is either manually or automatically rotated around a fixed point to increase the arc coverage of the system. In such embodiments, the system may be configured to detect that an incoming image is at the fringes of the system arc, and take another Reference Image thereby increasing the arc coverage.

Optionally, the system and method utilize systems and methods known in the digital arts to improve image quality including focus stacking where multiple images of the same scene, each focused at different distances, are combined into a single image and/or image averaging where multiple photos are stacked on top of each other and averaged together.

In some embodiments, the system is integrated to a ballistic processing, and map display capable computer application to display the projectile impact range (or distance) and the impact azimuth of the projectile.

Images with large amount of sky area with clouds do not provide reliable reference points. Accordingly, in some embodiments, the system is integrated to a horizon detection algorithm to filter out sky/cloud reference points thereby enhancing the reliability of the azimuth calculation. Methods of horizon detection are known in the art and include methods that rely on edge detection and/or machine learning.

In some embodiments, there is provided a computer program product. The computer program product generally represents computer-readable instruction means (instructions) stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories.

The term “instructions” as used with respect to this invention generally indicates a set of operations to be performed on a computer and may represent pieces of a whole program or individual, separable, software modules. Non-limiting examples of “instructions” include computer program code (source or object code) and “hard-coded” electronics (i.e., computer operations coded into a computer chip). The “instructions” may be stored on any non-transitory computer-readable medium such as a floppy disk, a CD-ROM, a flash drive, and in the memory of a computer.

In particular, the present invention provides a computer program product for digital image-referenced indirect target aiming. In some embodiments, the computer program product identifies an aiming that is colinear to the target's absolute azimuth from a Reference Image with an absolute azimuth in accordance with methods of the invention.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

We claim:

1. A computer implemented method of determining an aiming azimuth, the method comprising:
a. receiving a reference digital image and a subsequent digital image, wherein the reference digital image and the subsequent digital image are captured from a known fixed point and wherein the reference digital image and the subsequent digital image overlap;
b. determining net rotation between the reference digital image and the subsequent digital image;
c. receiving an absolute azimuth of the Reference Image;
d. calculating the azimuth of the subsequent digital image from the absolute azimuth and the net rotation.

2. The method of claim 1, wherein determining net rotation comprises determining a plurality of common points between the reference digital image and the subsequent digital image, calculating their rotations using pixel offsets. camera FOV (Field of View), applying accuracy rating filters, and optionally filtering out points in the sky such as clouds.

3. The method of claim 2, wherein the target azimuth is a plurality of azimuths and the target is a plurality of targets.

4. The method of claim 2, wherein the method is in real-time with rotation of a camera or video recorder capturing the digital images.

5. The method of claim 2, wherein:
a. a plurality of Reference Images covering different azimuths around a fixed point, or
b. a wide stitched image created by stitching multiple Reference Images with embedded azimuths is used to increase the probability of finding the azimuth of a subsequent image.

6. The method of claim 5 wherein an indication of accuracy rating is provided when the camera or video camera is rotated to be in line with a specific azimuth.

7. A computer implemented method of aiming at a target with a known target azimuth comprising:
a. capturing a reference digital image with a weapon mounted digital camera; the digital image with a known absolute azimuth;
b. calculating the difference between the known absolute azimuth and the known target azimuth;
c. rotating the weapon mounted digital camera the difference between the known absolute azimuth and the known target azimuth, thereby providing colinear targeting to the target.

8. A system comprising:
a. a source of digital images such as a database of images, a digital camera or digital video recorder;
b. one or more processor; and
c. memory storing one or more programs to be executed by the one or more processors, the one or more programs comprising instructions for the method of claim 1.

9. The system of claim 8, comprising a user interface configured to allow a user to aim at an object with known azimuth to create a Reference Image.

10. The system of claim 9, comprising an automated capability to:
a. create new Reference Image when the reference point count is low, but it still has a reliable aim azimuth, or
b. stitch a new Reference Image to the Reference Stitched image when the reference point count is low, but it still has a reliable azimuth.
